(19) United States
(12) Patent Application Publication
(10) Pub. No.: US 2006/0051086 A1
(43) Pub. Date: Mar. 9, 2006

(54) Method for photographically recording a cylindrical, especially plate-shaped object

(76) Inventors: Michael Schroter, Remscheid-luttringhausen (DE); Dieter Pfingsten, Remscheid-Lennep (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/535,956

(22) PCT Filed: Nov. 22, 2003
(86) PCT No.: PCT/EP03/13156

§ 371 Date: May 20, 2005

(30) Foreign Application Priority Data
Nov. 23, 2002 (DE) 102 54 883.8
Dec. 23, 2002 (DE) 102 61 502.0

(51) Int. Cl. G03D 13/00

(52) U.S. Cl. 396/661

(57) ABSTRACT

The invention relates to a method for the photographic representation of a cylindrical, especially plate-shaped object, having a front surface and an envelope surface, by means of a camera oriented towards the front surface. Said method uses a lens system having a beam path which is embodied in such a way that the envelope surface is represented as an annular surface surrounding the image of the front surface. Preferably, the diameter of the lens system is larger than the width of the workpiece. Alternatively, a mirror in the form of the inner surface of a conical envelope surrounds the object to be photographically represented, the camera being positioned with its lens system essentially on the conical axis. The object is illuminated by means of a ring of transparent material surrounding the object and having a light opening parallel to the cylindrical axis of the object and a light emergence surface which is in the form of a cylindrical envelope or a conical envelope, surrounds the envelope surface, and is essentially oriented towards the envelope surface.

The invention relates to a method for photographically recording a cylindrical, especially plate-shaped, object according to the preamble of claim 1. Such methods are, in particular, used for the quality control of objects, workpieces, coins and the like. The objects are also those which are applied to another object as cylindrical elevations, such as for example projections, raised portions, lettering, numbers or other marks and images, such as for example are to be found on coins.

With the known methods, the front surface can be photographically recorded and tested for faults in the quality. There are, however, no suitable methods for also producing a photographic recording of the envelope surface of the object or the relief-like raised portions on a flat surface, if the impractical possibility is excluded of arranging a plurality of cameras on the circumference of the object and orienting them toward the envelope surface or rotating the object once about 360° in front of the camera and thus repeatedly taking photographic recordings.

The object of the invention is to provide a photographic method for the quality control or identification of such objects, in which the front surface and simultaneously the envelope surface is photographically recorded in a single operating step.

The solution is revealed in claim 1.

The advantage of this solution is
that only one camera is required,
that the object can be moved, namely conveyed, relative to the recording camera,
that a plurality of objects can therefore be tested on the moving conveyor belt,
that the objects can be recorded from above and from below.

In this connection it is a further object to design the method
such that the handling of the object to be tested is restricted to a simple translational conveying motion and no further recording device is required for the object.

The appropriate design therefor is revealed in claim 2. In this connection, the entire lens system required can be integrated in the camera, so that the object and the camera can be freely moved relative to one another. This embodiment is, in particular, advantageous for testing workpieces of mass-produced articles, when a 100% quality control is to be carried out. A simplified lens system is revealed in the embodiment according to claim 7. This embodiment is suitable, in particular, for individual checking of circular cylindrical objects, such as for example collector coins.

In the method, particular attention is given to the illumination of the object. In this connection, the illumination of the front surface is carried out by conventional means, as the light sources are arranged in a non-glare manner relative to the camera but also without casting a shadow on the front surface. An advantageous illumination of the envelope surface—and in a suitable embodiment, also the front surface—is revealed in claim 3 and claim 4. In this respect, the front surface is illuminated in a non-glare and non-shadow-casting manner. Very frequently, it is also important to take a photographic recording of a cylindrical or plate-shaped object from below. The development according to claims 5, 18 and 19 is suitable therefor. The particular advantage of this development is that a simultaneous recording from above and below is possible and that the envelope surfaces are therefore also recorded twice and the two recordings can then be compared in turn with one another in order to detect defects. A plurality of torus—shell-shaped mirrors can be arranged concentrically with one another. In this manner the entire lower face of the object can be recorded by the camera from above.

As the photographic recording takes place in one operating step, it is suitable, in particular, for the quality control of a plurality of similar objects in the development according to claim 6.

Testing coins during the manufacture of coins and the recognition of coins in coin-operated vending machines, coin exchange machines, coin-operated meters and the like. This is a preferred application of the method according to the invention.

During the manufacture of tablets it is important that the active ingredients are contained in a specific quantity. Firstly, this a problem for the tablet manufacture, but secondly it is also a problem which arises during packaging as tablets which have too low a quantity, due to damage or defective production, have to be prevented from being packaged. As a result, the method is also used advantageously for the quality control of tablets and namely before packaging (claim 9) or after packaging (claim 10).

The quality control can then be carried out, in particular, when the photographic recording takes place with a digital camera, CCD camera (claim 11). The image comparison made possible thereby according to claim 12, allows the quality of the objects passing through to be compared with the quality of a reference object of which the front surface and envelope surface have previously been recorded (claim 12). In this connection, it is not only possible to record the embossed image on the front surface. The edges of the front surface and the envelope surface can, however, also be recorded and thus the length and width or diameter of the front surface and the thickness of the object or height of the edge can be recorded. The brightness of the recorded pixels, in particular, is therefore a suitable comparative criterion.

To compare data and depending on the level of resolution, very large amounts of data are to be compared with one another in order to determine image matches or non-matches. A reduction in the amount of data and thus an acceleration of the comparison method to be carried out in a computer is revealed in the embodiment according to claim 11 and 12.

The invention will be described hereinafter with reference to exemplified embodiments, in which:

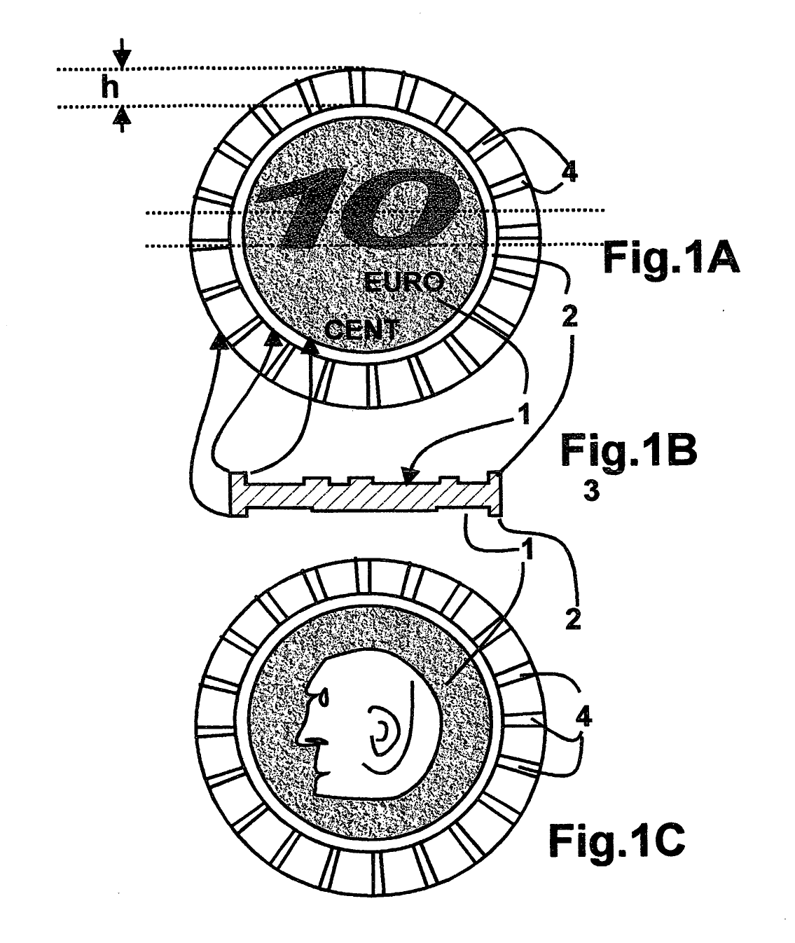

FIG. 1A is a view of a coin

FIG. 1B is the cross-section through the coin along the line 1

FIG. 1B is the view from below of a coin

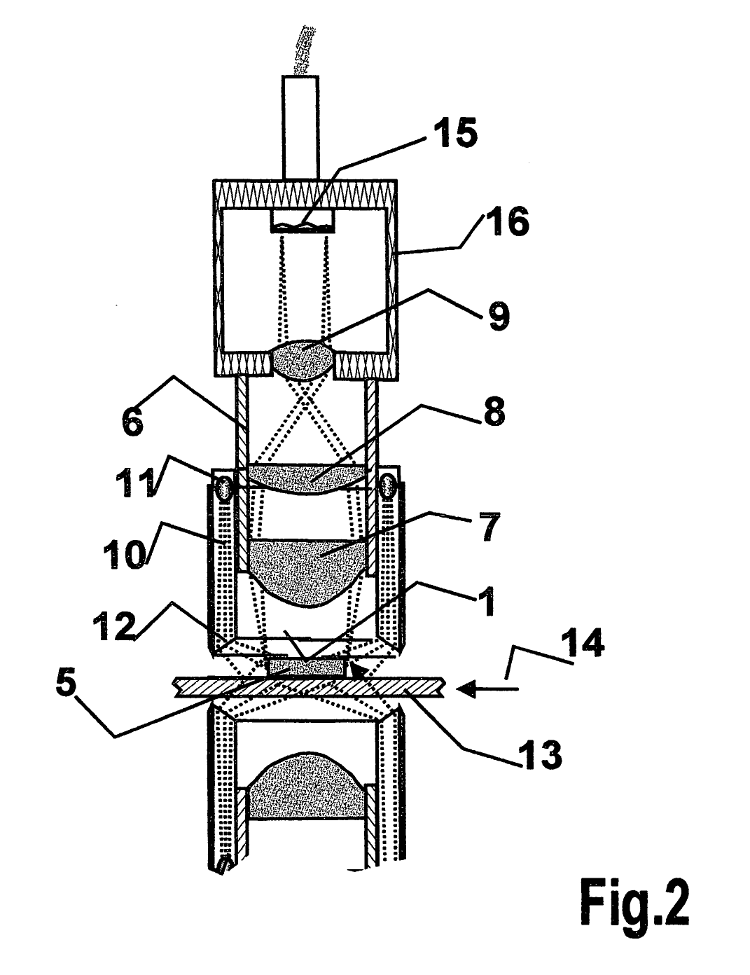

FIG. 2 is the cross-section through a device for carrying out the method

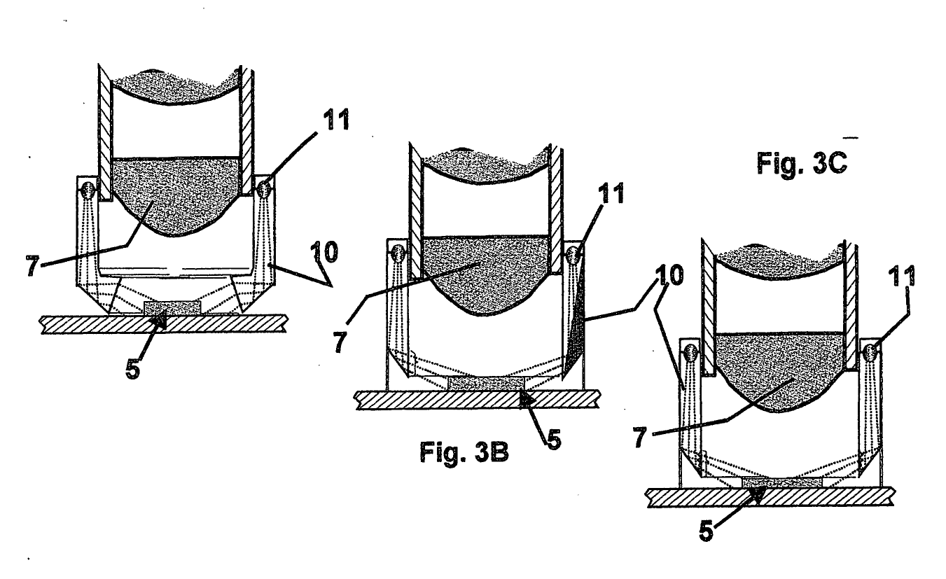

FIGS. 3A, 3B, 3C are embodiments for luminous rings for illuminating the edge

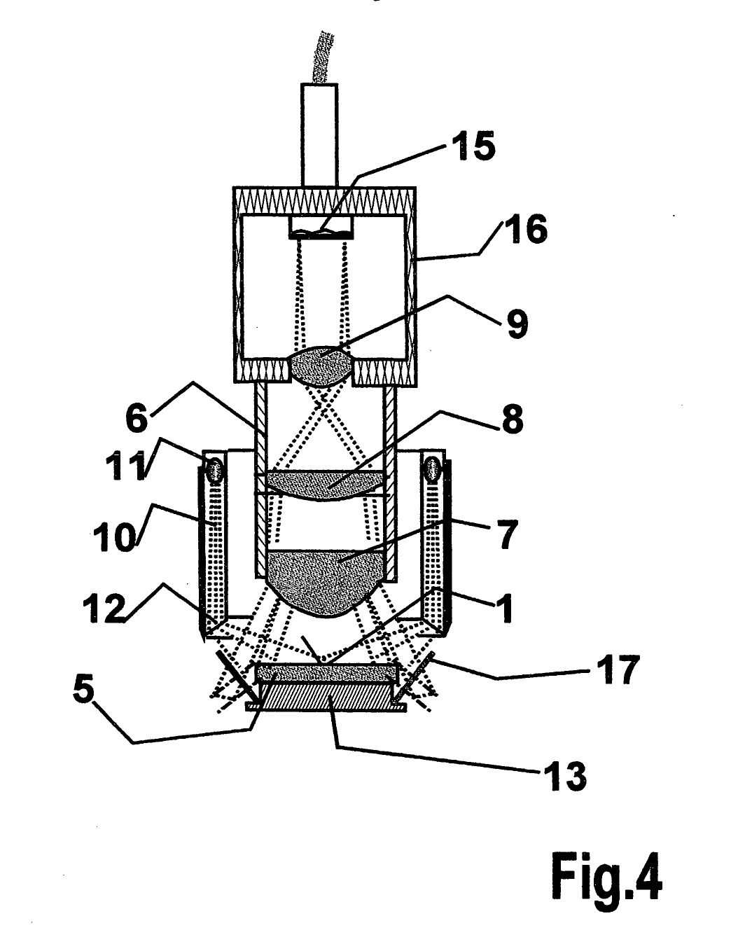

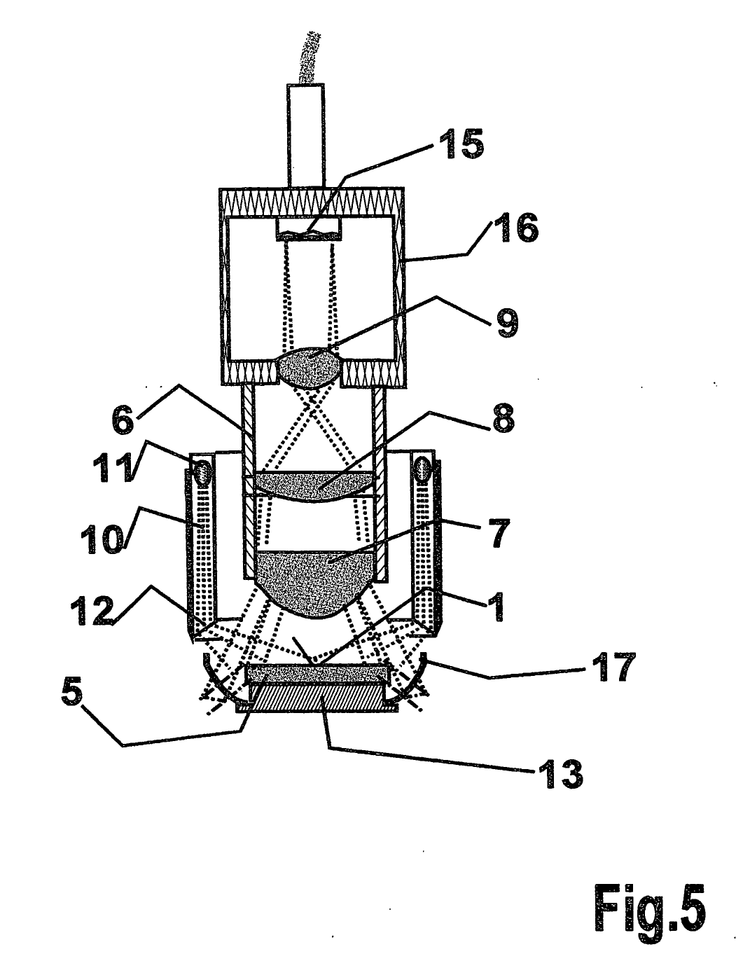

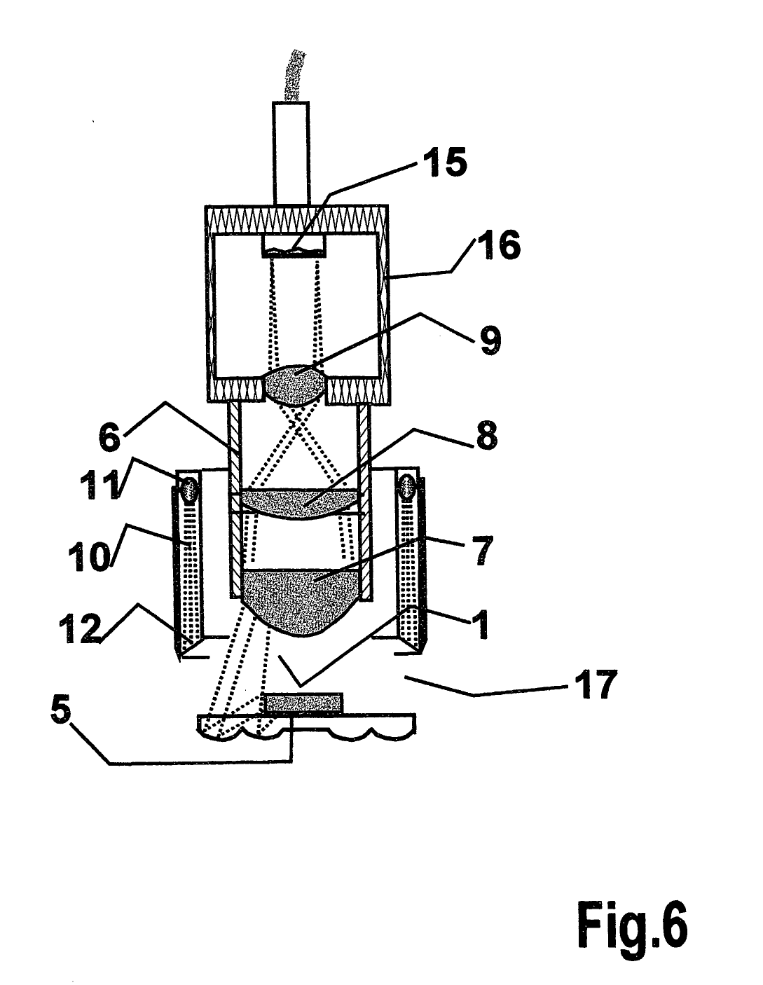

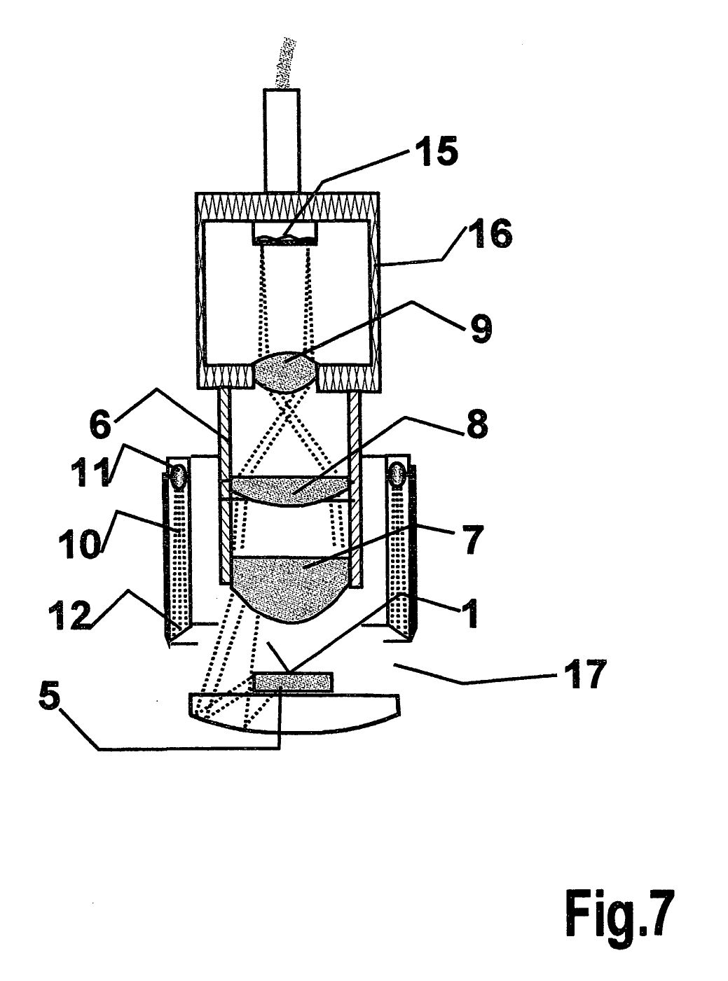

FIGS. 4 to 7 are cross-sections through a device for carrying out the method with a mirror surface

A coin is to be represented as an image as is shown diagrammatically in FIGS. 1A, 1B and 1C. The coin has an upper visible surface 1 on which, in particular, the value of the coin is shown and a lower visible surface 1, where a symbol, national emblem or the like is shown. The visible surfaces 1 are surrounded by an edge 2 which protrudes over the visible surface 1. The coin is configured as a circular cylindrical body and thus comprises an envelope surface 3 of which the form is typical for the coin. As a result, it is achieved that the coins can also be recognised by blind persons.

In the case shown, the coin comprises serrations in the form of grooves 4 which are arranged on the circumference at specific intervals.

The lower face of the coin, referred to in this application as the second visible surface, is differently formed. However, it is also typically formed for the value of the coin and similarly comprises an edge 2.

During testing of the coins, the following problems, in particular, occur:
Firstly, during embossing of the coins or subsequent checking, full quality control is to take place as to whether the two visible faces on the upper face and the lower face, including the edge and the envelope surfaces and also the alignment of the image representations conform to the standard. In this connection, it is noteworthy that between the alignment of the image on the upper face and the alignment of the image on the lower face there has to be a specific offset which is a feature of the value and genuineness of the coin. The photographic representation of the coin according to this invention, as is indicated in FIGS. 1A, 1B and 1C, allows all these tests by means of corresponding evaluation of the two recorded images. In this connection, in particular, it is also possible to test the thickness, as the width h, in which the edge is represented, is relative to the corresponding measurement with which a reference coin is represented in the same method.
A further task during coin testing is to recognise the value of the coins and their genuineness. This task applies, in particular, to coin-operated vending machines and coin-operated payment machines. In this connection, it is not important for all the characteristics to be checked, as consideration always has to be taken for wear and tear and slight damage to the coins. The image representation according to the invention is also able to accomplish this task. High speed is particularly required with this type of task. Thus it is sufficient for only one portion of the recorded pixels to be evaluated. It is, for example, possible that only the pixels on a narrow strip of narrow width in mm, are recorded, this strip passing through the diameter or being defined by two chords.

In any case, the evaluation is carried out by the pixels of a reference coin being previously recorded and stored and then the pixels of the coin to be tested being checked for matches with the stored pixels. The brightness, in particular, of the recorded pixels is taken into consideration as a criterion for testing. Suitable methods exist for this, the brightness values, in particular, being classified into levels in the computer being used for the evaluation and the recorded brightness values being associated with one of these levels and represented logically.

During this evaluation, the visualisation of the envelope surface according to this invention offers the particular advantage that the matching of the visible surface with the prescribed form of the edge is an accurate criterion for the value and the genuineness of the coin.

The device for photographically recording the coin is shown in FIG. 2. A digital camera 5 is oriented with its lens system, comprising the camera lens 7, converging lens 8 and eyepiece 9 connected in series, toward a plate-shaped object 5, for example the aforementioned coin. The lens system, in particular the camera lens 7, has a larger diameter than the largest width of the object 5. As a result, the light beams reflected from the envelope surface 3 are also partially propagated by the lens system. The light path of the lens system is calculated such that the image of the object, including its envelope surface, is imaged—as shown in FIG. 1—on the light sensitive receiver 15 of the camera.

For uniform illumination, in particular of the envelope surface, but also the visible surface 1, a luminous ring 10 is placed on the tube 6 of the camera which at least partially contains the lens system. This luminous ring is of hollow cylindrical construction and consists of a light transmitting, transparent or translucent material, for example glass or plastics. On the front surface of the luminous ring 10 facing away from the object to be photographed a plurality of light transmitters 11, for example LEDs (light emitting diodes) are preferably uniformly distributed. The illumination of the field of view can be determined by the distribution. The light beams penetrate the luminous ring 10 in the axial direction, parallel to the tube 6 and emerge on the opposing front surface 12. The luminous ring is formed in the region of this front surface 12, such that the front surface 12 is oriented toward the envelope surface 3 and preferably also toward the visible face 1 of the object 5. As a result, the front surface 12 forms an annular surface in the form of a conical envelope.

Specific embodiments of luminous rings are shown in FIG. 3 with different light paths. In each case, the light path is designed such that the object is well illuminated from the side and on the front surface. It can be seen that circular objects also require the emergence surface 12 to be of circular form. When angular objects are to be tested, another form and another distribution of the light sources 11 is optionally required to achieve optimum illumination. For the photographic recording, the object 5 can be mounted on an opaque carrier 13. In this connection, it can, for example, be a conveyor belt which is continually moved at high speed and thus feeds through a plurality of objects one after the other in the conveying direction 14 under the camera, so that each object can thus be photographically recorded with a short exposure time.

The base 13 can, however, also be a glass plate—as shown in FIG. 2. This glass plate allows the object 5 to be photographically recorded simultaneously from the upper face and the lower face. To this end—as indicated in FIG. 2—a camera with a lens system and illumination is arranged below the carrier 13 in an identical manner to on the upper face. The two cameras are connected to the same computer—not shown here. The computer contains storage space for storing the brightness values of the individual pixels which have been recorded by the individual sensor elements of the sensor 15. These brightness values are classified into different grey scales which are easily differentiated from one another. For the imaging of the object, the recorded brightness values are therefore converted into graded brightness values so that the individual image elements are easily differentiated from one another.

Furthermore, the computer has storage space in order to store the reference images of a reference object or a plurality of different reference objects which have previously been photographically recorded and which have the standard form. By comparing the reference images with the test images the computer firstly determines the rotational position of the test objects 5 and then the matches or deviations of the individual pixels of the respective test image to the pixels of the reference images, with regard to the recorded and stored brightness values. By the simultaneous recording of the upper face and the lower face of a test object and the processing of the test images in a common computer, the offset of the imaging can be determined on the upper face and the lower face and calculated.

FIG. 4 shows a device for carrying out the method in which lens systems can be used which have a smaller diameter than the largest extension of the test object. This device is therefore suitable in particular for test objects which are larger than inexpensive lens systems. The description of this invention applies to this device, with the exception that the light path of the camera lens does not directly record the reflected light beams of the envelope surface but the reflection of a mirror surface 17. This has the form of the inner face of a conical envelope which records the object on its axis, so that the inner face is oriented toward the envelope surface of the object. In this connection, the included angle is approximately 45°. The disadvantage of this embodiment is that when testing a series of test objects, the conveying of the test objects is not as simple as with the aforementioned device.

The examination of coins was exclusively disclosed above. However, other plate-shaped objects can also be examined which do not necessarily have to be circular. When, within the scope of this application, imaging and visible faces are referred to, the arrangement of holes, grooves and the like are also implied thereby, as can occur with technical objects. The particularities of the method according to the invention which cannot be achieved with any other method, consist primarily in:
that the offset of the visible surfaces with the form of the envelope surface can be detected,
that the thickness of the object can be detected,
that the edges where the front surfaces intersect with the envelope surface are represented; as a result it is possible to check very easily, to determine ridges, notches and other defects of the circumferential edges;
that, simultaneously with the upper face, the envelope of the object can also be made visible and possibly also the lower side can be simultaneously recorded with the envelope. As a result, the angular offset between the upper face and lower face and the angular offset of the front faces relative to the envelope surface can be recorded and checked.

### LIST OF REFERENCE NUMERALS

1. Upper visible surface 1, lower visible face 1
2. Edge 2
3. Envelope surface 3
4. Grooves 4
5. Plate-shaped object 5, coin, test object, reference
6. Tube 6
7. Camera lens 7
8. Converging lens 8
9. Eyepiece 9
10. Luminous ring 10
11. Light transmitter 11
12. Front surface 12 opposing front surface, emergence surface 12
13. Base 13, glass plate, conveyor belt
14. Conveying direction 14
15. Light sensitive receiver 15
16. Digital camera 16, camera 16
17. Mirror, mirror surface

1. Method for photographically representing a cylindrical, especially plate-shaped, object which comprises a front surface and an envelope surface by means of a camera oriented toward the front surface, characterised by the use of a lens system as a camera lens, in the focal point of which the front surface is substantially positioned and which is designed with its light path such that the envelope surface is imaged as an annular surface which surrounds the image of the front surface.

2. Method according to claim 1, characterised in that in its diameter the lens system substantially exceeds the largest possible width of the workpiece.

3. Method according to claim 1, characterised by the illumination of the object by means of a ring made from transparent material, such as glass or Plexiglass which surrounds the object and which has a light opening parallel to the cylindrical axis of the object and a cylindrical envelope- or conical envelope-shaped light emergence surface which surrounds the envelope surface and is substantially oriented toward the envelope surface.

4. Method according to claim 3, characterised in that the luminous ring is constructed from transparent or translucent material as a hollow cylindrical envelope, in that light transmitters are arranged on a front face to radiate light beams into the hollow cylindrical envelope of the luminous ring and in that the envelope of the luminous ring has an emergence surface for the light beams on its end facing the object, which is inclined toward the envelope of the object, such that the light beams are incident on the envelope, preferably a plurality of light transmitters being distributed on the circumference of the front face, such that by the arrangement of light transmitters a desired illumination of the envelope surface of the object can be set.

5. Method according to claim 1, characterised in that the object positioned on the glass plate is photographed from below, preferably the recording from above and below being simultaneously set and the image evaluation of the two faces and the envelope being set relative to one another.

6. Method according to claim 1, characterised in that the object is moved or conveyed during the photographic recording and in that a short exposure is used during the photographic recording.

7. Method according to claim 1, characterised by a mirror in the form of the inner face of a conical envelope which surrounds the object to be photographically represented, the camera being positioned with its lens system substantially on the conical axis.

8. Method according to claim 1, characterised by the application of the method to coins.

9. Method according to claim 1, characterised by the application of the method to tablets.

10. Method according to claim 9, characterised by the application of the method to tablets which are packaged on a pallet with transparent film applied and with the transparent film facing the camera.

11. Method according to claim 1, characterised by the application of a digital camera (CCD camera), preferably the lens system being the camera lens of the camera.

12. Method according to claim 11, characterised by the evaluation of the recorded image by comparing the recorded pixels with the stored pixels of a reference object of the same type previously photographically recorded.

13. Method according to claim 12, characterised in that the image comparison is merely on a selection of pixels, in particular of pixels arranged in a line or of pixels which are arranged on a strip of which the width is smaller, in particular substantially smaller, than the corresponding dimension of the object.

14. Method according to claim 1, characterised in that during the image evaluation the brightness of the recorded pixels is evaluated.

15. Method according to claim 1, characterised in that the aperture ratio of the camera lens as a focal length/diameter quotient is less than 0.5.

16. Method according to claim 1, characterised in that the camera lens is produced from a series of planar-convex lenses.

17. Method according to claim 1, characterised in that a diaphragm is arranged between the eyepiece and the camera lens.

18. Method according to claim 1, characterised by a mirror in the form of a concave mirror which is arranged below the object to be represented photographically, such that the object is positioned substantially at the focal point of the concave mirror and the camera with its lens system is positioned substantially on the axis of the concave mirror, preferably the concave mirror forming the concave lower face of a glass plate on which the object is positioned.

19. Method according to claim 1, characterised by a mirror in the form of the inner face of a torus—shell (annular shell) which is arranged below the object to be photographically represented, such that the object is positioned substantially in the focal point of the shell and the camera is positioned with its lens system substantially on the axis of the shell.
